(19) United States
(12) Patent Application Publication
(10) Pub. No.: US 2025/0061121 A1
(43) Pub. Date: Feb. 20, 2025

(54) ENTITY LINKING METHOD AND APPARATUS, COMPUTER DEVICE, AND STORAGE MEDIUM

(71) Applicant: Tencent Technology (Shenzhen) Company Limited, Shenzhen (CN)

(72) Inventors: Zhenran XU, Shenzhen (CN); Yulin CHEN, Shenzhen (CN); Baotian HU, Shenzhen (CN); Zifei SHAN, Shenzhen (CN)

(73) Assignee: Tencent Technology (Shenzhen) Company Limited, Shenzhen, GD (CN)

(21) Appl. No.: 18/935,376

(22) Filed: Nov. 1, 2024

Related U.S. Application Data
(63) Continuation of application No. PCT/CN2023/129854, filed on Nov. 6, 2023.

(30) Foreign Application Priority Data
Dec. 14, 2022 (CN) 202211612479.5

(51) Int. Cl. G06F 16/2458; G06F 16/28; G06F 40/126; G06F 40/174; G06F 40/186; G06F 40/279

(52) U.S. Cl. CPC G06F 16/2465; G06F 16/288; G06F 40/126; G06F 40/174; G06F 40/186; G06F 40/279

(57) ABSTRACT

An entity linking method is provided. Text content including text characters and descriptive information that explains the text characters is obtained. At least one candidate entity content corresponding to the text characters based on the descriptive information is obtained. First screening template content is filled with content based on the text characters to generate second screening template content. Merged text content is generated based on the descriptive information, the at least one candidate entity content, and the second screening template content. Target entity content corresponding to the text characters is obtained based on the merged text content.

### RELATED APPLICATIONS

The present application is a continuation of International Application No. PCT/CN2023/129854, filed on Nov. 6, 2023, which claims priority to Chinese Patent Application No. 202211612479.5, filed on Dec. 14, 2022. The entire disclosures of the prior applications are hereby incorporated by reference.

### FIELD OF THE TECHNOLOGY

This disclosure relates to the field of computer technologies, including to an entity linking method and apparatus, a computer device, and a storage medium.

### BACKGROUND OF THE DISCLOSURE

Entity linking may mean mapping mention text content in text content to target entity content in a knowledge base. For example, mention content “apple” in text content “This apple is big and sweet” needs to be linked to target entity content “fruit”, rather than target entity content “company”. Entity linking is applied in many fields.

### SUMMARY

An aspect of this disclosure provides an entity linking method. In the method, text content including text characters and descriptive information that explains the text characters is obtained. At least one candidate entity content corresponding to the text characters based on the descriptive information is obtained. First screening template content is filled with content based on the text characters to generate second screening template content. Merged text content is generated based on the descriptive information, the at least one candidate entity content, and the second screening template content. Target entity content corresponding to the text characters is obtained based on the merged text content.

An aspect of this disclosure further provides an entity linking apparatus, the apparatus including processing circuitry configured to obtain text content including text characters and descriptive information that explains the text characters. The processing circuitry is configured to obtain at least one candidate entity content corresponding to the text characters based on the descriptive information. The processing circuitry is configured to perform content filling on first screening template content based on the text characters to generate second screening template content. The processing circuitry is configured to generate merged text content based on the descriptive information, the at least one candidate entity content, and the second screening template content. The processing circuitry is configured to obtain target entity content corresponding to the text characters based on the merged text content.

An aspect of this disclosure further provides a computer program product or a computer program, including computer instructions, the computer instructions being stored in a non-transitory computer-readable storage medium. A processor of a computer device reads the computer instructions from the non-transitory computer-readable storage medium, and executes the computer instructions, to cause the computer device to perform the method provided in this disclosure.

Correspondingly, an embodiment of this disclosure further provides a non-transitory computer-readable storage medium, storing instructions which when executed by a processor cause the processor to implement the entity linking method provided in any implementation of the embodiments of this disclosure.

### BRIEF DESCRIPTION OF THE DRAWINGS

To describe technical solutions of embodiments of this disclosure more clearly, drawings for describing the embodiments are briefly described below. The drawings in the following description show only some embodiments of this disclosure, and a person skilled in the art may derive other drawings from these drawings.

FIG. 1 is a schematic diagram of a scenario of an entity linking method according to an example of this disclosure.

FIG. 2 is a schematic flowchart of an entity linking method according to an example of this disclosure.

FIG. 3 is a schematic diagram of another scenario of an entity linking method according to an example of this disclosure.

FIG. 4 is a schematic diagram of another scenario of an entity linking method according to an example of this disclosure.

FIG. 5 is a schematic diagram of another scenario of an entity linking method according to an example of this disclosure.

FIG. 6 is another schematic flowchart of an entity linking method according to an example of this disclosure.

FIG. 7 is a schematic structural diagram of an entity linking apparatus according to an example of this disclosure.

FIG. 8 is a schematic structural diagram of a computer device according to an example of this disclosure.

### DETAILED DESCRIPTION

Technical solutions in embodiments of this disclosure are described below with reference to the drawings. However, the described embodiments are some rather than all of the embodiments of this disclosure. Other embodiments obtained by a person skilled in the art based on the embodiments of this disclosure fall within the protection scope of this disclosure.

During entity linking, incomprehensive information in a knowledge base for some professional fields results in a decreased accuracy of the entity linking. For example, the knowledge base has little information for professional fields such as biomedicine and chemistry, resulting in a low accuracy of entity linking of mention text content in the fields.

Therefore, the embodiments of this disclosure provide an entity linking method and apparatus, a computer device, and a storage medium, which can improve an accuracy of entity linking.

The entity linking method in the embodiments of this disclosure may be performed by an entity linking apparatus. The entity linking apparatus may be integrated in a computer device. The computer device may include at least one of a terminal, a server, and the like. To be specific, the entity linking method provided in the embodiments of this disclosure may be performed by the terminal, or may be performed by the server, or may be jointly performed by the terminal device and the server that can communicate with each other.

The terminal may include but is not limited to a smartphone, a tablet computer, a notebook computer, a personal computer (PC), a smart home appliance, a wearable electronic device, a virtual reality (VR)/augmented reality (AR) device, an on-board terminal, and an intelligent voice interaction device.

The server may be a communication server or a backend server between a plurality heterogeneous systems, or may be an independent physical server, or may be a server cluster formed by a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a big data platform, and an artificial intelligence (AI) platform, or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The embodiments of this disclosure are applicable to various scenarios, including but not limited to a cloud technology, AI, intelligent traffic, and assisted driving.

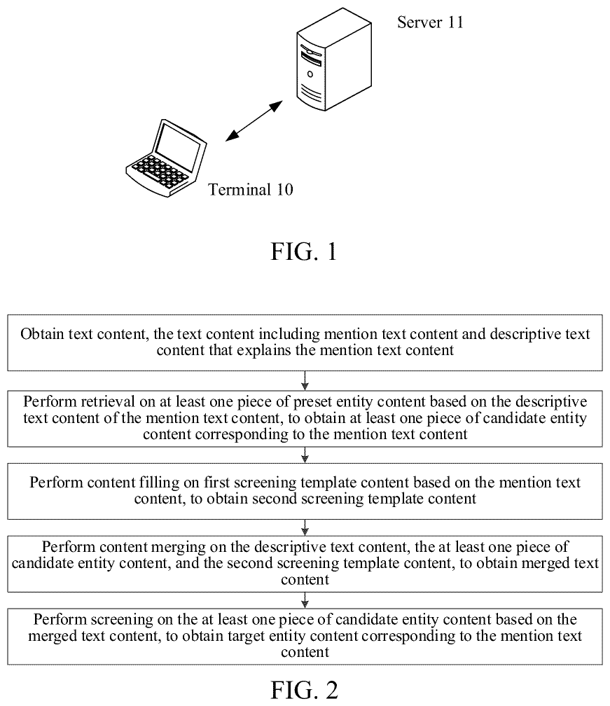

In an embodiment, as shown in FIG. 1, the entity linking apparatus may be integrated in a computer device such as a terminal or a server, to implement the entity linking method provided in the embodiments of this disclosure. Specifically, a server 11 may obtain text content through a terminal 10, the text content including mention text content and descriptive text content that explains the mention text content; perform retrieval on at least one piece of preset entity content based on the descriptive text content of the mention text content, to obtain at least one piece of candidate entity content corresponding to the mention text content; perform content filling on preset screening template content based on the mention text content, to obtain target screening template content; perform content merging on the descriptive text content, the at least one piece of candidate entity content, and the target screening template content, to obtain merged text content; and perform screening on the at least one piece of candidate entity content based on the merged text content, to obtain target entity content corresponding to the mention text content.

Detailed descriptions are provided below. A description order of the following embodiments is not construed as a limitation on an order of the embodiments.

The embodiments of this disclosure are described from a perspective of the entity linking apparatus. The entity linking apparatus may be integrated in an electronic device. The electronic device may be a server, or may be a device such as a terminal.

As shown in FIG. 2, an embodiment of this disclosure provides an entity linking method. A specific process includes the following operations:

101: Obtain text content, the text content including mention text content and descriptive text content that explains the mention text content.

The text content may include content composed of words. For example, the text content may include a sentence, a paragraph, or the like.

The mention text content (e.g., text characters) may include an object in the text content for which entity linking is to be performed. For example, the mention text content may be an object for which the entity linking needs to be performed specified by a user. For example, the mention text content may be a pronoun, a noun, a phrase, or the like in the text content. For example, a personal name, a place name, an institution name, and the like that appear in the text content maybe mention text content. For example, for text content “Apple is headquartered in San Francisco, USA”, if the user specifies “Apple” for entity linking, “Apple” may be mention text content. For another example, if the user specifies “San Francisco” for entity linking, “San Francisco” may be mention text content.

The descriptive text content (e.g., descriptive information) may include content in the text content that explains the mention text content. For example, the descriptive text content may be the text content. For another example, the descriptive text content may be content in the text content other than the mention text content. For example, for the text content “Apple is headquartered in San Francisco, USA”, if the user specifies “Apple” for the entity linking, the descriptive text content may be “Apple is headquartered in San Francisco, USA”.

As described above, in the related art, target entity content corresponding to the mention text content is often determined through the mention text content. For some professional fields, since a knowledge base has incomprehensive information, determining the target entity content through the mention text content results in a relatively low accuracy of the entity linking. To resolve the problem, in this embodiment of this disclosure, the target entity content is determined in combination with the mention text content and the descriptive text content. Through the mention text content and the descriptive text content, an information amount for the entity linking can be increased, thereby improving the accuracy of the entity linking.

Entity linking may mean mapping mention text content in text content to target entity content in a knowledge base.

The target entity content may include content introducing background of the mention text content. The target entity content is determined from preset entity content. The preset entity content may be entity content pre-stored in the knowledge base. For example, a common knowledge base for a biomedical field is a unified medical language system (UMLS). The knowledge base covers medical and medicine-related disciplines such as clinical medicine, a basic medicine, pharmacy, biology, and medical supervision, and includes approximately 2,000,000 medical concepts. Each medical concept in the UMLS may be regarded as preset entity content.

In an embodiment, the entity content may have various forms. For example, the entity content may be a text, a link, a picture, a video, or the like.

For example, target entity content obtained through the entity linking on mention text content is a link. When triggering the link, a user may obtain text content that explains background of the mention text content. For another example, target entity content obtained through the entity linking on mention text content may directly be a video that explains background information of the mention text content.

In an embodiment, the text content may be obtained.

For example, a large amount of text content exists in an Internet page such as news and a blog. Most webpages lack background description of nouns and the like that appear in the text content. If the user triggers a noun in news for entity linking when browsing the news through a terminal device, the terminal may transmit the text content of the news to a server, and then the server may obtain the text content of the news.

For another example, in the biomedical field, a doctor may specify mention text content in a description of a patient for a state of an illness, and perform the entity linking to obtain medical entity content corresponding to the mention text content. Then the doctor may infer an illness of the patient based on the medical entity content. In this way, assistance in diagnosing the state of an illness by the doctor is achieved through the mention text content.

In some embodiments, after the text content is obtained, parsing may be performed on the text content, to obtain the mention text content and the descriptive text content that explains the mention text content.

In this embodiment of this disclosure, identifiers may be added to the text content in the news or the blog on the Internet page. For example, relevant identifiers (which may be referred to as descriptive text identifiers) may be added to each sentence and each paragraph in the news. In addition, when the user specifies a noun in the text content for entity linking, the terminal may generate a mention text identifier for the noun. Then the parsing may be performed on the text content to obtain a descriptive text identifier and the mention text identifier added to the text content. Then mention text content and descriptive text content in the text content may be determined based on the identifiers.

For example, after the identifiers are added, the text content may include the mention text content, the mention text identifier corresponding to the mention text content, the descriptive text content, and the descriptive text identifier corresponding to descriptive text content. For example, the text content may be “[CLS] Recently my [START] stomach aches [END] [SEP]”. “Recently my stomach aches” may be descriptive text content, and [CLS] and [SEP] may be descriptive text identifiers. “stomach aches” may be mention text content, and [START] and [END] may be mention text identifiers. Therefore, after obtaining the text content, the server may traverse the text content, to obtain the mention text identifier and the descriptive text identifier in the text content. Then, the server may intercept the mention text content from the text content based on the mention text identifier, and intercept the descriptive text content from the text content based on the descriptive text identifier.

102: Perform retrieval on at least one piece of preset entity content based on the descriptive text content of the mention text content, to obtain at least one piece of candidate entity content corresponding to the mention text content.

In an embodiment, in the related art, the target entity content corresponding to the mention text content is directly determined based on the mention text content, which results in a low accuracy of the entity linking. To improve the accuracy of the entity linking, in this embodiment of this disclosure, the retrieval may be first performed on the preset entity content, to obtain the at least one piece of candidate entity content corresponding to the mention text content. Then screening may be on the at least one piece of candidate entity content, to obtain the target entity content.

The preset entity content may be entity content pre-stored in the knowledge base. For example, a common knowledge base for a biomedical field is the UMLS. Each medical concept in the UMLS may be regarded as preset entity content.

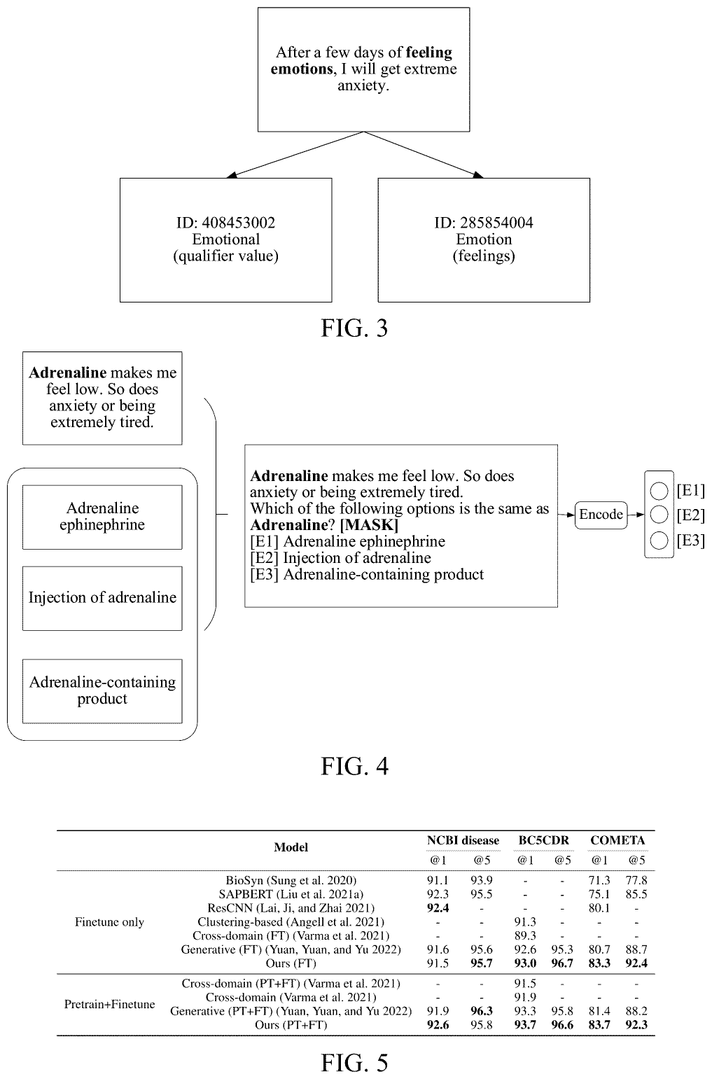

The candidate entity content may be retrieved entity content that has an association relationship with the mention text content. For example, as shown in FIG. 3, for text content “After a few days of feeling emotions, I will get extreme anxiety”, “feeling emotions” is mention text content, and “After a few days of feeling emotions, I will get extreme anxiety” is descriptive text content. The retrieval may be performed on the at least one piece of preset entity content based on the descriptive text content of the mention text content, to obtain the at least one piece of candidate entity content corresponding to the mention text content. For example, candidate entity content with an identifier (ID) of 408453002 and candidate entity content with an ID of 285854004 may be obtained.

The retrieval may be performed on the at least one piece of preset entity content in a plurality of manners, to obtain the at least one piece of candidate entity content corresponding to the mention text content.

In some embodiments, the mention text content may carry the mention text identifier, and the descriptive text content may carry the descriptive text identifier. The operation “perform retrieval on at least one piece of preset entity content based on the descriptive text content of the mention text content, to obtain at least one piece of candidate entity content corresponding to the mention text content” may include:
performing encoding on the mention text content and the descriptive text content respectively based on the mention text identifier and the descriptive text identifier, to obtain mention text encoding information corresponding to the mention text content and descriptive text encoding information corresponding to the descriptive text content;
performing feature mining on the mention text encoding information based on the descriptive text encoding information, to obtain feature mining information of the mention text encoding information; and
performing the retrieval on the at least one piece of preset entity content based on the feature mining information of the mention text encoding information, to obtain the at least one piece of candidate entity content corresponding to the mention text content.

In some embodiments, the encoding may be performed on the mention text content and the descriptive text content respectively based on the mention text identifier and the descriptive text identifier, to obtain the mention text encoding information corresponding to the mention text content and the descriptive text encoding information corresponding to the descriptive text content.

The performing encoding on the mention text content and the descriptive text content may mean converting the mention text content and the descriptive text content into mathematical expressions. For example, the mention text content and the descriptive text content may be converted into vectors or the like.

For example, feature extraction, forward propagation, and nonlinear transformation may be performed on the mention text content and the descriptive text content, to obtain the mention text encoding information corresponding to the mention text content and the descriptive text encoding information corresponding to the descriptive text content.

In some embodiments, to improve an accuracy of the retrieval, the feature mining may be performed on the mention text encoding information based on the descriptive text encoding information, to obtain the feature mining information of the mention text encoding information. For example, during the feature mining, splicing may be performed on the descriptive text encoding information and the mention text encoding information, to obtain spliced text encoding information. Then the feature extraction, the forward propagation, and the nonlinear transformation may be performed on the spliced text encoding information, to obtain the feature mining information of the mention text encoding information.

In some embodiments, the retrieval may be performed on the at least one piece of preset entity content based on the feature mining information of the mention text encoding information, to obtain the at least one piece of candidate entity content corresponding to the mention text content.

For example, the encoding may be performed on the preset entity content, to obtain entity content encoding information of the preset entity content. Then the feature mining may be performed on the entity content encoding information, to obtain feature mining information of the entity content encoding information.

Then a similarity between the feature mining information of the mention text content and the feature mining information of the preset entity content may be calculated. Then the at least one piece of candidate entity content is screened out from the at least one piece of preset entity content based on the similarity. For example, the similarity between the feature mining information of the mention text content and the entity content encoding information of the preset entity content may be calculated based on a Euclidean distance, a cosine similarity, or the like. Then the similarities may be ranked in descending order, and preset entity content corresponding to top 10 similarities may be selected as candidate entity content.

In some embodiments, the retrieval may be performed on the at least one piece of preset entity content by using an AI model, to obtain the at least one piece of candidate entity content corresponding to the mention text content. Specifically, the operation “perform retrieval on at least one piece of preset entity content based on the descriptive text content of the mention text content, to obtain at least one piece of candidate entity content corresponding to the mention text content” may include:
performing the retrieval on the at least one piece of preset entity content by using a preset retrieval model based on the descriptive text content of the mention text content, to obtain the at least one piece of candidate entity content corresponding to the mention text content.

The preset retrieval model may be an AI model.

AI is a theory, a method, a technology, and an disclosure system that use a digital computer or a machine controlled by the digital computer to simulate, extend, and expand human intelligence, so as to sense an environment, obtain knowledge, and obtain a result with knowledge. In other words, AI is a comprehensive technology of computer science, which attempts to understand essence of intelligence and produces a new intelligent machine that can respond in a manner similar to human intelligence. The AI is to study the design principles and implementation methods of various intelligent machines, to enable the machines to have functions of sensing, reasoning, and decision-making.

The AI technology is a comprehensive discipline, which involves a wide range of fields including both hardware-level technologies and software-level technologies. Basic AI technologies generally include technologies such as a sensor, a dedicated AI chip, cloud computing, distributed storage, a big data processing technology, an operating/interaction system, and electromechanical integration. AI software technologies mainly include major directions such as a computer vision technology, a speech processing technology, a natural language processing technology, and machine learning (ML)/deep learning.

The ML is an interdisciplinary field, which involves a plurality of disciplines such as the theory of probability, statistics, the approximation theory, convex analysis, and the theory of algorithm complexity. The ML specializes in how a computer simulates or realizes learning behaviors of humans to obtain new knowledge or skills, and reorganizes existing knowledge structures to keep improving performance thereof. The ML is the core of the AI to make computers intelligent, which is applied in all fields of the AI. The ML and the deep learning generally include technologies such as an artificial neural network, a confidence network, reinforcement learning, transfer learning, inductive learning, and learning from demonstration. The reinforcement learning is a field in machine learning, which emphasizes how to act based on an environment to improve expected benefits. Deep reinforcement learning combines the deep learning and the reinforcement learning, to solve a problem regarding reinforcement learning by using the deep learning technology.

For example, the preset retrieval model may be at least one of a convolutional neural network (CNN) model, a de-convolutional network (DN) model, a deep neural network (DNN) model, a deep convolutional inverse graphics network (DCIGN) model, a region-based convolutional network (RCNN) model, a self-attentive sequential recommendation (SASRec) model, a bidirectional encoder representations from transformers (BERT) model, a SAPBERT model, a conditional random field (CRF) model, and the like.

For example, when the text content is content of the biomedical field, the preset retrieval model may be the SAPBERT model. The retrieval may be performed on the at least one piece of preset entity content by using the SAPBERT model based on the descriptive text content of the mention text content, to obtain the at least one piece of candidate entity content corresponding to the mention text content. The SAPBERT model is a BERT-based model, and performs spatial self-alignment on a representation of a biomedical entity by using a target function of metric learning of the UMLS.

In an embodiment, the preset retrieval model may include a mention encoder and an entity encoder. The mention encoder may be configured to perform encoding on the mention text content and the descriptive text content, and the entity encoder may be configured to perform encoding on the preset entity content. Therefore, the encoding may be performed on the mention text content by using the mention encoder, to obtain an encoding vector corresponding to the mention text content. In addition, the encoding may be performed on the preset entity content by using the entity encoder, to obtain an encoding vector corresponding to the preset entity content. Then a similarity between the encoding vector corresponding to the mention text content and the encoding vector corresponding to the preset entity content may be calculated. Next, the at least one piece of candidate entity content corresponding to the mention text content may be selected from the preset entity content based on the similarity.

In an embodiment, before the performing the retrieval on the at least one piece of preset entity content by using a preset retrieval model, training may be performed on a to-be-trained retrieval model, to obtain the preset retrieval model. To improve performance of the preset retrieval model, pretraining may be performed on the to-be-trained retrieval model, to obtain an initially trained retrieval model. Then training may be performed on the initially trained retrieval model, to obtain the preset retrieval model.

Specifically, the method in this embodiment of this disclosure may further include:
obtaining the to-be-trained retrieval model, a first text content sample, and a second text content sample;
performing the pretraining on the to-be-trained retrieval model by using the first text content sample, to obtain the initially trained retrieval model; and
performing the training on the initially trained retrieval model by using the second text content sample, to obtain the preset retrieval model.

The to-be-trained retrieval model may be a model of which performance still needs training. The first text content sample may be configured for performing the training on the to-be-trained retrieval model. The second text content sample may be configured for performing the training on the initially trained retrieval model. The first text content sample and the second text content sample being different text content samples.

The pretraining is performed on the to-be-trained retrieval model, to obtain the initially trained retrieval model. The initially trained retrieval model obtained through the pretraining has specific functions. For example, the initially trained retrieval model can achieve text recognition. To enable the initially trained retrieval model to achieve retrieval, the training may be performed on the initially trained retrieval model, to obtain the preset retrieval model.

In an embodiment, since the preset retrieval model may include the mention encoder and the entity encoder, during the pretraining of the to-be-trained retrieval model, training may be performed on both of the mention encoder and the entity encoder may be trained, so that the mention encoder and the entity encoder share a model parameter. Similarly, during the training of the initially trained retrieval model, training is performed on both of the mention encoder and the entity encoder, so that the mention encoder and the entity encoder share a model parameter.

In an embodiment, the pretraining may be performed on the to-be-trained retrieval model in a plurality of manners, to obtain the initially trained retrieval model. For example, the pretraining may be performed on the to-be-trained retrieval model by using a “prompt learning” paradigm, to obtain the initially trained retrieval model. Prompt learning means performing training on a model through unsupervised learning in a condition with a series of specified appropriate prompts. For example, during execution of a sentiment recognition task, a social media text is provided to predict a sentiment label. For example, for an input text “I missed the bus again today.”, a prompt text “I feel very______” is added behind the input text to cause a language model to predict words on the line. In this way, a classification task is transformed into a task already executed by a language model in a pretraining stage. Similarly, a machine translation task may be transformed into a similar form by using a similar method. For example, for the input text “I missed the bus again today.”, a downstream task is to translate the input text into English, i.e., the model needs to return an English output text. A prompt “Chinese: <Chinese Text> English:______.” may be designed to cause the language model to fill the line with a corresponding English translation. Through the design of an appropriate prompt, a behavior of the language model may be changed, so that the language model can produce a correct output without downstream task training.

For example, the training is performed on the to-be-trained retrieval model through the “prompt learning”. Specifically, the operation “performing the pretraining on the to-be-trained retrieval model by using the first text content sample, to obtain the initially trained retrieval model” may include:
performing parsing on the first text content sample, to obtain at least one text content unit;
determining a target text content unit in the at least one text content unit;
performing masking on the target text content unit in the first text content sample, to obtain a masked text content sample; and
performing the training on the to-be-trained retrieval model by using the masked text content sample, to obtain the initially trained retrieval model.

The text content unit may refer to content that constitutes the first text content sample. For example, the text content unit may include a phrase or a word. For example, assuming that the first text content sample is “The weather is really nice today”, a text content unit of the first text content unit may include “today”, “weather”, “really”, and “nice”. The masking means shielding or replacing one or more text content units in the text content by using preset characters. For example, after the masking is performed on the target text content unit “weather” in the first text content unit, a masked text content sample “[START] [MASKED] is really nice today [END]” is obtained.

In some embodiments, the parsing may be performed on the first text content sample, to obtain the at least one text content unit. For example, text recognition may be performed on the first text content sample, to obtain constituents of the text content unit. Then the first text content sample may be split into a plurality of text content units based on a recognition result.

In some embodiments, the masking may be performed on one or more of the text content units, to form a prompt text. Then the training may be performed on the to-be-trained retrieval model may be trained by using the prompt text, to obtain the initially trained retrieval model. Therefore, the target text content unit may be determined in the at least one text content unit. For example, any text content unit may be selected as the target text content unit. Then the masking may be performed on the target text content unit in the first text content sample, to obtain the masked text content sample. Next, the training may be performed on the to-be-trained retrieval model by using the masked text content sample, to obtain the initially trained retrieval model. For example, prediction may be performed on the masked text content sample by using the to-be-trained retrieval model, to obtain predicted content of the masked text content sample. Then a similarity between the predicted content and the target text content unit may be calculated. A model parameter of the to-be-trained retrieval model is adjusted based on the similarity, to obtain the initially trained retrieval model. For another example, a matching degree between the predicted content and the masked text content sample may be calculated. The model parameter of the to-be-trained retrieval model is adjusted based on the matching degree, to obtain the initially trained retrieval model.

For another example, the first text content sample may be spliced by a plurality of phrases with the same or similar meanings. Then the masking may be performed on any word, to obtain the masked text content sample. Then the training may be performed on the to-be-trained retrieval model by using the masked text content sample, to obtain the initially trained retrieval model.

Due to a problem of incomprehensive information in a relevant knowledge base, the model is pretrained by using the above method, so that information included in the pretrained model may be stimulated through a prompt word, thereby improving performance of the initially trained retrieval model. Performing the training on the initially trained retrieval model to obtain the preset retrieval model can improve performance of the preset retrieval model.

In some embodiments, after the initially trained retrieval model is obtained, the training may be performed on the initially trained retrieval model by using the second text content sample, to obtain the preset retrieval model. For example, encoding and feature mining may be performed on the second text content sample by using the initially trained retrieval model, to obtain feature mining information of the second text content sample. Then loss information between the feature mining information and label information may be calculated, and a model parameter of the initially trained retrieval model may be adjusted based on the loss information, to obtain the preset retrieval model.

103: Perform content filling on first screening template content based on the mention text content, to obtain second screening template content.

In some embodiments, after the candidate entity content is retrieved, disambiguation may be performed on the candidate entity content. Since incomprehensive information in the knowledge base for some professional fields results in a decreased accuracy of entity linking, in this embodiment of this disclosure, information enhancement may be performed on the mention text content, to increase an information amount of the mention text content, thereby improving the accuracy of the entity linking.

To increase the information amount of the mention text content, the content filling may be performed on preset screening template content based on the mention text content, to obtain target screening template content.

The preset screening template content may be a preset sentence configured for screening the candidate entity content. For example, as shown in FIG. 4, the preset screening template content may be “Which of the following options is the same as______?”.

In some embodiments, the content filling may be performed on the first screening template content (the preset screening template content) based on the mention text content, to obtain the second screening template content (the target screening template content).

For example, the mention text content may be added to a to-be-filled position in the preset screening template content, to obtain the target screening template content.

For example, as shown in FIG. 4, text content is “Adrenaline makes me feel low. So does anxiety or being extremely tired.” is provided, and “Adrenaline” is mention text content.

After the preset screening template content is filled with the mention text content, target screening template content “Which of the following options is the same as Adrenaline?” is obtained.

104: Perform content merging on the descriptive text content, the at least one piece of candidate entity content, and the second screening template content, to obtain merged text content.

In some embodiments, after the target screening template content is obtained, the content merging may be performed on the descriptive text content, the at least one piece of candidate entity content, and the target screening template content, to obtain the merged text content.

In some embodiments, during the content merging, an entity content identifier may be generated for each piece of candidate entity content. Then the entity content identifiers, the descriptive text content, the at least one piece of candidate entity content, and the target screening template content may be merged.

Specifically, the operation “perform content merging on the descriptive text content, the at least one piece of candidate entity content, and the target screening template content, to obtain merged text content” may include:
generating an entity content identifier for each of the at least one piece of candidate entity content;
performing splicing on each piece of candidate entity content and the entity content identifier corresponding to the candidate entity content, to obtain at least one piece of spliced entity content;
performing masking on the target screening template content, to obtain masked screening template content; and
performing splicing on the descriptive text content, the at least one piece of spliced entity content, and the masked screening template content based on a preset splicing format, to obtain the merged text content.

In an embodiment, the entity content identifier may be generated for the at least one piece of candidate entity content. For example, as shown in FIG. 4, an entity content identifier may be generated for each of candidate entity content “Adrenaline ephinephrine”, “Injection of adrenaline”, and “Adrenaline-containing product”.

For example, the entity content identifier corresponding to the candidate entity content “Adrenaline ephinephrine” is E1.

The entity content identifier corresponding to the candidate entity content “Injection of adrenaline” is E2.

The entity content identifier corresponding to the candidate entity content “Adrenaline-containing product” is E3.

In an embodiment, the splicing may be performed on each piece of the candidate entity content and the entity content identifier corresponding to the candidate entity content, to obtain the at least one piece of spliced entity content.

For example, as shown in FIG. 4, the spliced entity content may be “[E1] Adrenaline ephinephrine”.

In an embodiment, the masking may be performed on the target screening template content, to obtain the masked screening template content. Then, the splicing may be performed on the descriptive text content, the at least one piece of spliced entity content, and the masked screening template content based on the preset splicing format, to obtain the merged text content. For example, FIG. 4 may be a schematic diagram of the merged text content.

105: Perform screening on the at least one piece of candidate entity content based on the merged text content, to obtain target entity content corresponding to the mention text content.

In an embodiment, after the merged text content is obtained, the screening may be performed on the at least one piece of candidate entity content based on the merged text content, to obtain the target entity content corresponding to the mention text content.

The screening may be performed on the at least one piece of candidate entity content based on the merged text content in a plurality of manners, to obtain the target entity content corresponding to the mention text content.

For example, the screening may be performed on the at least one piece of candidate entity content by using the AI model based on the merged text content, to obtain target entity content corresponding to the mention text content. Specifically, the operation “perform screening on the at least one piece of candidate entity content based on the merged text content, to obtain target entity content corresponding to the mention text content” may include:

performing the screening on the at least one piece of candidate entity content by using a preset disambiguation model based on the merged text content, to obtain the target entity content corresponding to the mention text content.

The preset disambiguation model may be the CNN, BERT, or SAPBERT model.

For example, the screening may be performed on the at least one piece of candidate entity content by using a trained SAPBERT model based on the merged text content, to obtain the target entity content corresponding to the mention text content.

In some embodiments, before the disambiguation is performed by using the disambiguation model, a to-be-trained disambiguation model may be obtained, and then training is performed on the to-be-trained disambiguation model, to obtain the preset disambiguation model. Specifically, the method in this embodiment of this disclosure may further include:
obtaining the to-be-trained disambiguation model, a text content sample, and at least one entity content sample;
performing information enhancement on the at least one entity content sample, to obtain an enhanced entity content sample;
performing the training on the to-be-trained disambiguation model by using the enhanced entity content sample, to obtain an initially trained disambiguation model;
performing training on the initially trained disambiguation model by using the text content sample, to obtain the preset disambiguation model.

In some embodiments, a process of performing the training on the to-be-trained disambiguation model may include two parts. The first part includes: performing the information enhancement on the at least one entity content sample, to obtain the enhanced entity content sample; and then performing pretraining on the to-be-trained disambiguation model by using the enhanced entity content sample, to obtain the initially trained disambiguation model. The second part includes: performing the training on the initially trained disambiguation model by using the text content sample, to obtain the preset disambiguation model.

In some embodiments, due to a problem that the knowledge base has insufficient information for a professional field, for example, the biomedical knowledge base, the UMLS, has descriptions for only 7% of entities, the information enhancement may be performed on the entity content sample, to obtain the enhanced entity content sample. For example, the same or similar entity content may be associated to obtain the enhanced entity content sample.

Specifically, the operation “performing information enhancement on the at least one entity content sample, to obtain an enhanced entity content sample” may include:
performing association on the at least one entity content sample, to obtain a plurality of entity content samples having an association relationship;
performing division on the plurality of entity content samples having the association relationship, to obtain a first entity content sample and a second entity content sample;
performing masking on the first entity content sample, to obtain a masked entity content sample; and
performing splicing on the masked entity content sample and the second entity content sample, to obtain the enhanced entity content sample.

The plurality of entity content samples having the association relationship may include entity content having the same meaning. For example, “stomachache”, “stomach ache”, and “sore stomach” are a plurality of different entity content samples having the same meaning, and the entity content samples have an association relationship.

In some embodiments, the masking may be performed on the plurality of entity content samples having the association relationship. Therefore, the division may be performed on the plurality of entity content samples having the association relationship, to obtain the first entity content sample and the second entity content sample. The first entity content sample is a sample that needs masking. For example, the plurality of entity content samples having the association relationship may be randomly divided into two types of entity content samples, namely, the first entity content sample and the second entity content sample. For example, if 3 entity content samples exist, any one of the 3 entity content samples may be randomly specified as the first entity content sample, and the other two may be specified as the second entity content sample.

Then the masking may be performed on the first entity content sample, to obtain the masked entity content sample. The splicing is performed on the masked entity content sample and the second entity content sample, to obtain the enhanced entity content sample. For example, for the entity content samples “stomachache”, “stomach ache”, and “sore stomach” having the association relationship, masking may be performed on “stomachache”, to obtain a masked entity content sample. Then splicing may be performed on the masked entity content sample and the second entity content sample, to obtain an enhanced entity content sample “[CLS] [MASKED] [OR] stomach ache [OR] sore stomach [SEP]”. [OR] is configured for isolating different entity content samples, [CLS] and [SEP] are configured for marking the enhanced entity content sample, and [MASKED] may indicate that the entity content sample is masked.

Then the training may be performed on the to-be-trained disambiguation model by using the enhanced entity content sample, to obtain the initially trained disambiguation model. For example, encoding may be performed on the enhanced entity content sample by using the to-be-trained disambiguation model, to obtain encoding information of the enhanced entity content sample. Then prediction may be performed on the enhanced entity content sample by using the to-be-trained disambiguation model, to obtain a predicted result corresponding to the masked entity content sample. Then loss information between the predicted result and the first entity content sample is calculated, and a parameter of the to-be-trained disambiguation model is adjusted based on the loss information, to obtain the initially trained disambiguation model.

Then the training may be performed on the initially trained disambiguation model by using the text content sample, to obtain the preset disambiguation model. For example, the text content sample may include a mention text content sample and a descriptive text content sample. The operation “performing the training on the initially trained disambiguation model by using the text content sample, to obtain the preset disambiguation model” includes:
obtaining at least one candidate entity content sample corresponding to the mention text content sample;
generating a merged text content sample based on the mention text content sample, the descriptive text content sample, and the at least one candidate entity content sample;
performing screening on the at least one candidate entity content sample by using the initially trained disambiguation model based on the merged text content sample, to obtain a target entity content sample corresponding to the mention text content sample;
calculating model loss information based on the target entity content sample; and
performing parameter adjustment on the initially trained disambiguation model based on the model loss information, to obtain the preset disambiguation model.

In some embodiments, the at least one candidate entity content sample corresponding to the mention text content sample may be obtained. For the operation “obtaining at least one candidate entity content sample corresponding to the mention text content sample”, reference may be made to operation 102, which is not repeated herein.

In some embodiments, the merged text content sample may be generated based on the mention text content sample, the descriptive text content sample, and the at least one candidate entity content sample. For the operation “generating a merged text content sample based on the mention text content sample, the descriptive text content sample, and the at least one candidate entity content sample”, reference may be made to operations 103 and 104, which is not repeated herein.

In some embodiments, the screening may be performed on the at least one candidate entity content sample by using the initially trained disambiguation model based on the merged text content sample, to obtain the target entity content sample corresponding to the mention text content sample. Then the model loss information may be calculated based on the target entity content sample.

In some embodiments, the mention text content sample may include a positive mention text content sample and a negative mention text content sample. Specifically, the operation “calculating model loss information based on the target entity content sample” may include:
calculating a positive sample similarity between the positive mention text content sample and a target entity content sample corresponding to the positive mention text content sample and a negative sample similarity between the negative mention text content sample and a target entity content sample corresponding to the negative mention text content sample;
respectively performing a nonlinear computation on the positive sample similarity and the negative sample similarity, to obtain a computed positive sample similarity and a computed negative sample similarity;
performing a statistical computation on the computed positive sample similarity corresponding to the positive mention text content sample, to obtain a statistical positive sample similarity; and performing summation on the statistical positive sample similarity to the computed negative sample similarity, to obtain the model loss information.

In some embodiments, the positive mention text content sample and the negative mention text content sample form a sample pair. The positive mention text content sample and the negative mention text content sample are a pair of samples that include the same mention text content but correspond to different entity content. The pair of samples include similar content with differences. For example, apple in Apple Inc. and apple in a fruit of apple may form a sample pair.

In some embodiments, the positive sample similarity between the positive mention text content sample and the target entity content sample corresponding to the positive mention text content sample and the negative sample similarity between the negative mention text content sample and the target entity content sample corresponding to the negative mention text content sample may be calculated. For example, the negative sample similarity and the positive sample similarity may be calculated based on a Euclidean distance and a cosine distance.

In an embodiment, the nonlinear computation may be respectively performed on the positive sample similarity and the negative sample similarity, to obtain the computed positive sample similarity and the computed negative sample similarity. For example, an exponential operation and a logarithmic operation may be respectively performed on the positive sample similarity and the negative sample similarity, to obtain the computed positive sample similarity and the computed negative sample similarity.

Then the summation may be performed on the statistical positive sample similarity and the computed negative sample similarity, to obtain the model loss information.

For example, the model loss information may be calculated based on the following equation:

$$L = \frac{1}{\vert {x}_{b} \vert} {\sum }_{i = 1}^{\vert {x}_{b} \vert} ( \frac{1}{α} log ( 1 + {\sum }_{n ∈ {N}_{i}} {e}^{α ( {S}_{i n} - ϵ )} ) + \frac{1}{β} log ( 1 + {\sum }_{p ∈ {P}_{i}} {e}^{α ( {S}_{i p} - ϵ )} ) )$$

Nᵢ may represent a negative mention text content sample set, n may represent the negative mention text content sample, Pᵢ may represent a positive mention text content sample set, and p may represent the positive mention text content sample. Sᵢₙ may be configured for representing the negative sample similarity, and Sᵢₚ may be configured for representing the positive sample similarity. α and β may represent temperature factors, which may be constants. β may be a threshold. X_{b} may represent a quantity of positive and negative sample pairs.

Then the parameter adjustment may be performed on the initially trained disambiguation model based on the model loss information, to obtain the preset disambiguation model.

In some embodiments, the operation “performing screening on the at least one piece of candidate entity content based on the merged text content, to obtain target entity content corresponding to the mention text content” may include:
performing encoding on the merged text content, to obtain merged encoding information corresponding to the merged text content;
performing feature mining on the merged encoding information corresponding to the merged text content, to obtain feature mining information corresponding to the merged text content; and
performing prediction on masked information in the merged text content based on the feature mining information corresponding to the merged text content, to obtain the target entity content.

In some embodiments, for the operation “performing encoding on the merged text content, to obtain merged encoding information corresponding to the merged text content”, reference may be made to operation “performing encoding on the mention text content and the descriptive text content respectively based on the mention text identifier and the descriptive text identifier, to obtain mention text encoding information corresponding to the mention text content and descriptive text encoding information corresponding to the descriptive text content”, which is not repeated herein.

In some embodiments, for the operation “performing feature mining on the merged encoding information corresponding to the merged text content, to obtain feature mining information corresponding to the merged text content”, reference may be made to the operation “performing feature mining on the mention text encoding information based on the descriptive text encoding information, to obtain feature mining information of the mention text encoding information”, which is not repeated herein.

In some embodiments, the prediction may be performed on the masked information in the merged text content based on the feature mining information corresponding to the merged text content, to obtain the target entity content. The masked information is masked content of the masked screening template content that constitutes the merged text content. For example, as shown in FIG. 4, prediction may be performed on [MASK] in the merged text content, i.e., prediction may be performed to determine candidate entity content which is [MASK].

In this embodiment of this disclosure, the text content may be obtained, the text content including the mention text content and the descriptive text content that explains the mention text content; the retrieval is performed on the at least one piece of preset entity content based on the descriptive text content of the mention text content, to obtain the at least one piece of candidate entity content corresponding to the mention text content; the content filling is performed on the preset screening template content based on the mention text content, to obtain the target screening template content; the content merging is performed on the descriptive text content, the at least one piece of candidate entity content, and the target screening template content, to obtain the merged text content; and the screening is performed on the at least one piece of candidate entity content based on the merged text content, to obtain the target entity content corresponding to the mention text content. In this way, the accuracy of the entity linking can be improved.

For example, the method provided in this embodiment of this disclosure is applied to the medical field. In this disclosure, the method in the embodiments of this disclosure is compared with another entity linking method in the biomedical field. Another entity linking method may include BioSyn, SAPBERT, ResCNN, Clustering-based, Cross-domain, and Generative. Experimental results may be shown in FIG. 5. Under a setting in which only fine tuning is performed on a training set (Finetune only), the model proposed in the embodiments of this disclosure achieved optimal results on BC5CDR and COMETA, and if an additional pretraining operation is performed (Pretrain+Finetune), this disclosure refreshed optimal results achieved by historically proposed models on three data sets, which demonstrates effectiveness of improvement in the preset retrieval model and the preset disambiguation model.

For another example, compared with the generative method in which large-scale pretraining is performed, the self-supervised pretraining method provided in the embodiments of this disclosure brings a higher improvement on National Center of Biotechnology Information (NCBI) diseases and the same improvement in BC5CDR. As described in a paper on the Generative method, pretraining of the Generative method takes 24 hours on 6 A100 graphics processing units (GPUs), while one round of pretraining of the method proposed in the embodiments of this disclosure only takes 1 hour on 1 A100 GPU (10 rounds of pretraining were performed), which indicates that less computing power is needed, and no annotated data is needed to perform supervised training.

In the embodiments of this disclosure, the text content may be obtained, the text content including the mention text content and the descriptive text content that explains the mention text content. the retrieval is performed on the at least one piece of preset entity content based on the descriptive text content of the mention text content, to obtain the at least one piece of candidate entity content corresponding to the mention text content; the content filling is performed on the preset screening template content based on the mention text content, to obtain the target screening template content; the content merging is performed on the descriptive text content, the at least one piece of candidate entity content, and the target screening template content, to obtain the merged text content; and the screening is performed on the at least one piece of candidate entity content based on the merged text content, to obtain the target entity content corresponding to the mention text content. In this way, the accuracy of the entity linking can be improved.

A detailed description is further provided below by using examples based on the method described in the above embodiments.

In the embodiments of this disclosure, the entity linking method in the embodiments of this disclosure is described by using an example in which the method is integrated in a server.

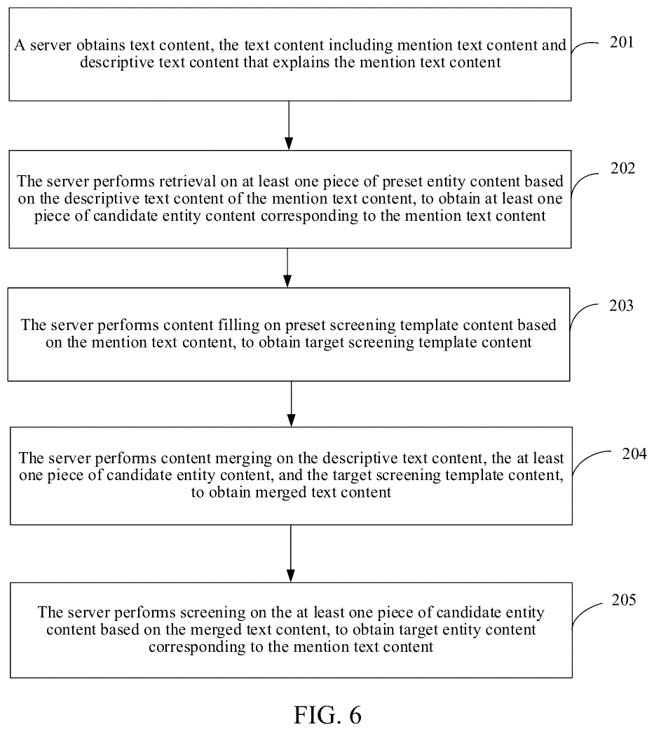

In some embodiments, as shown in FIG. 6, a specific process of an entity linking method is as follows:

201: A server obtains text content, the text content including mention text content and descriptive text content that explains the mention text content.

For example, the server may obtain text content related to biomedicine. For example, the text content may be “Adrenaline makes me feel low. So does anxiety or being extremely tired”. “Adrenaline” is mention text content of the text content, and “Adrenaline makes me feel low. So does anxiety or being extremely tired” may be descriptive text content.

202: The server performs retrieval on at least one piece of preset entity content based on the descriptive text content of the mention text content, to obtain at least one piece of candidate entity content corresponding to the mention text content.

For example, the retrieval may be performed on the at least one piece of preset entity content by using a preset retrieval model based on the descriptive text content of the mention text content, to obtain the at least one piece of candidate entity content corresponding to the mention text content. For example, 3 pieces of candidate entity content, namely, “Adrenaline ephinephrine”, “Injection of adrenaline”, and “Adrenaline-containing product” may be obtained.

In some embodiments, the preset retrieval model may adopt a form of a dual encoder, for example, a mention encoder and an entity encoder for coded information. An input to the mention encoder considers a context. An example of the input is “[CLS] Recently my [START] stomach aches [END] [SEP] (recently my stomach aches).”, where [START] and [END] are configured for indicating a beginning and an end of a mention, [CLS] and [SEP] are configured for indicating a beginning and an end of the input, and a vector at a token [CLS] of an output is used as a mention representation. An input to the entity encoder considers all names of an entity. An example of the input is “[CLS] stomachache [OR] stomach ache [OR] sore stomach [SEP]”, where [OR] is configured for isolating different aliases of the entity, and a vector at the token [CLS] is used as an entity representation. The mention encoder and the entity encoder are initialized by using a parameter of SAPBERT [2] and share the parameter. During prediction, an entity is called by using a vector closest to the mention.

203: The server performs content filling on preset screening template content based on the mention text content, to obtain target screening template content.

For example, as shown in FIG. 4, the preset screening template content may be “Which of the following options is the same as______?”.

For example, as shown in FIG. 4, text content is “Adrenaline makes me feel low. So does anxiety or being extremely tired.” is provided, and “Adrenaline” is mention text content. As described above, the content filling means filling a preset position in the preset screening template content with the mention text content. After the preset screening template content is filled with the mention text content, target screening template content “Which of the following options is the same as Adrenaline?” is obtained.

204: The server performs content merging on the descriptive text content, the at least one piece of candidate entity content, and the target screening template content, to obtain merged text content.

For example, an entity content identifier may be generated for the at least one piece of candidate entity content. For example, as shown in FIG. 4, an entity content identifier may be generated for each of candidate entity content “Adrenaline ephinephrine”, “Injection of adrenaline”, and “Adrenaline-containing product”. For example, the entity content identifier corresponding to the candidate entity content “Adrenaline ephinephrine” is E1. The entity content identifier corresponding to the candidate entity content “Injection of adrenaline” is E2. The entity content identifier corresponding to the candidate entity content “Adrenaline-containing product” is E3.

Then splicing may be performed on each piece of the candidate entity content and the entity content identifier corresponding to the candidate entity content, to obtain the at least one piece of spliced entity content. For example, as shown in FIG. 4, the spliced entity content may be “[E1] Adrenaline ephinephrine”.

Then masking may be performed on the target screening template content, to obtain masked screening template content. Then, the splicing may be performed on the descriptive text content, the at least one piece of spliced entity content, and the masked screening template content based on the preset splicing format, to obtain the merged text content. For example, FIG. 4 may be a schematic diagram of the merged text content.

205: The server performs screening on the at least one piece of candidate entity content based on the merged text content, to obtain target entity content corresponding to the mention text content.

For example, the screening may be performed on the at least one piece of candidate entity content by using a preset disambiguation model based on the merged text content, to obtain the target entity content corresponding to the mention text content. Since the merged text content is obtained through the splicing on the candidate entity content and the descriptive text content, the preset disambiguation model can focus on both a mention context and all candidate entities, including an interaction between a mention and an entity, and an interaction between entities.

In some embodiments, training may be performed on a to-be-trained disambiguation model, to obtain the preset disambiguation model. For example, a “self-supervised” knowledge base-enhanced pretraining method may be introduced to stimulate information included in the model by using some prompt words, thereby improving performance of the model. For example, corresponding to a cloze template during disambiguation, the method adopts a manner of predicting a word at [MASK]. To enable the model to learn a plurality of pieces of name information of the same entity content, one word of a name representing the entity content may be changed to [MASK], and other names of the entity content may be used as prompts for the model to predict [MASK]. For example, an entity has 3 names, namely, “epidermolysis bullosa junctional herlitz type”, “epidermolysis bullosa generalized atrophic benign”, and “epidermolysis bullosa letali”. One word of each of the three names may be randomly replaced with [MASK]. In this case, an example input of the model is “epidermolysis bullosa junctional [MASK] type [OR] epidermolysis [MASK] generalized atrophic benign [OR] epidermolysis bullosa [MASK]”. The model needs to predict words at [MASK].

In this embodiment of this disclosure, the server obtains the text content, the text content including the mention text content and the descriptive text content that explains the mention text content; the server performs the retrieval on the at least one piece of preset entity content based on the descriptive text content of the mention text content, to obtain the at least one piece of candidate entity content corresponding to the mention text content; the server performs the content filling on the preset screening template content based on the mention text content, to obtain the target screening template content; the server performs the content merging on the descriptive text content, the at least one piece of candidate entity content, and the target screening template content, to obtain the merged text content; and the server performs the screening on the at least one piece of candidate entity content based on the merged text content, to obtain the target entity content corresponding to the mention text content. In this way, an accuracy of the entity linking in the biomedical field can be improved.

To implement the entity linking method provided in the embodiments of this disclosure more effectively, in some embodiments, an entity linking apparatus is further provided. The entity linking apparatus may be integrated in a computer device. Nouns in this embodiment have the same meanings as those in the above entity linking method. For specific implementation details, reference may be made to the descriptions in the method embodiments.

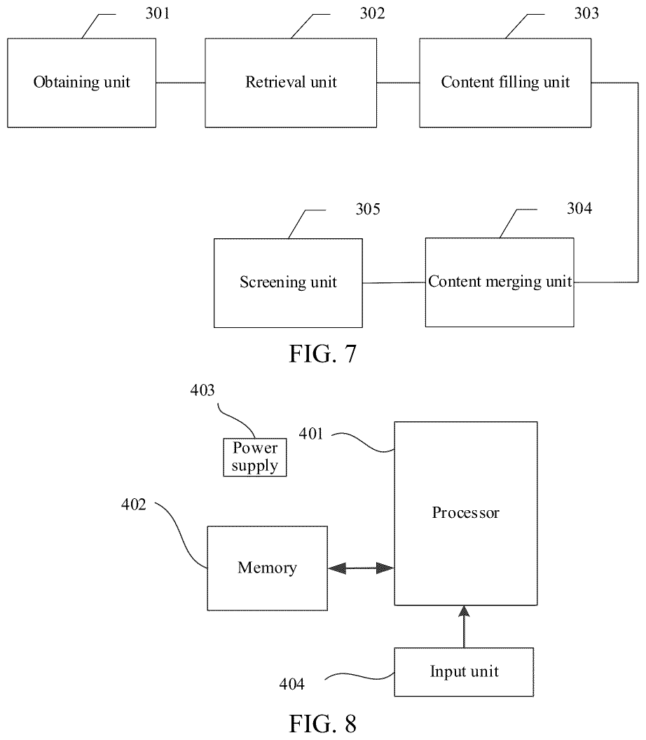

In an embodiment, an entity linking apparatus is provided. The entity linking apparatus may be specifically integrated in a computer device. As shown in FIG. 7, the entity linking apparatus includes an obtaining unit 301, a retrieval unit 302, a content filling unit 303, a content merging unit 304, and a screening unit 305. Details are as follows:

The obtaining unit 301 is configured to obtain text content, the text content including mention text content and descriptive text content that explains the mention text content.

The retrieval unit 302 is configured to perform retrieval on at least one piece of preset entity content based on the descriptive text content of the mention text content, to obtain at least one piece of candidate entity content corresponding to the mention text content.

The content filling unit 303 is configured to perform content filling on first screening template content based on the mention text content to obtain second screening template content.

The content merging unit 304 is configured to perform content merging on the descriptive text content, the at least one piece of candidate entity content, and the second screening template content, to obtain merged text content.

The screening unit 305 is configured to perform screening on the at least one piece of candidate entity content based on the merged text content, to obtain target entity content corresponding to the mention text content.

In an embodiment, the retrieval unit 302 may include:
an encoding subunit, configured to perform encoding on the mention text content and the descriptive text content respectively based on the mention text identifier and the descriptive text identifier, to obtain mention text encoding information corresponding to the mention text content and descriptive text encoding information corresponding to the descriptive text content;
a feature mining subunit, configured to perform feature mining on the mention text encoding information based on the descriptive text encoding information, to obtain feature mining information of the mention text encoding information; and
a first retrieval subunit, configured to perform the retrieval on the at least one piece of preset entity content based on the feature mining information of the mention text encoding information, to obtain the at least one piece of candidate entity content corresponding to the mention text content.

In an embodiment, the content merging unit 304 may include:
an identifier generation subunit, configured to generate an entity content identifier for each of the at least one piece of candidate entity content;
a splicing subunit, configured to perform splicing on each piece of candidate entity content and the entity content identifier corresponding to the candidate entity content, to obtain at least one piece of spliced entity content;
a first masking subunit, configured to perform masking on the second screening template content, to obtain masked screening template content; and
a first splicing subunit, configured to perform splicing on the descriptive text content, the at least one piece of spliced entity content, and the masked screening template content based on a preset splicing format, to obtain the merged text content.

In an embodiment, the retrieval unit 302 may include:
a second retrieval subunit, configured to perform the retrieval on the at least one piece of preset entity content by using a preset retrieval model based on the descriptive text content of the mention text content, to obtain the at least one piece of candidate entity content corresponding to the mention text content.

In an embodiment, the screening unit 305 may include: a screening subunit, configured to perform the screening on the at least one piece of candidate entity content by using a preset disambiguation model based on the merged text content, to obtain the target entity content corresponding to the mention text content.

In an embodiment, the entity linking apparatus may include:
a first obtaining unit, configured to obtain a to-be-trained disambiguation model, a text content sample, and at least one entity content sample;
an information enhancement unit, configured to perform information enhancement on the at least one entity content sample, to obtain an enhanced entity content sample;
a first training unit, configured to perform training on the to-be-trained disambiguation model by using the enhanced entity content sample, to obtain an initially trained disambiguation model; and
a second training unit, configured to perform training on the initially trained disambiguation model by using the text content sample, to obtain the preset disambiguation model.

In an embodiment, the information enhancement unit may include:
an association recognition subunit, configured to perform association on the at least one entity content sample, to obtain a plurality of entity content samples having an association relationship;
a division subunit, configured to divide the plurality of entity content samples having the association relationship into two types of entity content samples, to obtain a first entity content sample and a second entity content sample;
a second masking subunit, configured to perform masking on the first entity content sample, to obtain a masked entity content sample; and
a second splicing subunit, configured to perform splicing on the masked entity content sample and the second entity content sample, to obtain the enhanced entity content sample.

In an embodiment, the second training unit may include:
an obtaining subunit, configured to obtain at least one candidate entity content sample corresponding to the mention text content sample;
a generation subunit, configured to generate a merged text content sample based on the mention text content sample, the descriptive text content sample, and the at least one candidate entity content sample;
a screening subunit, configured to perform screening on the at least one candidate entity content sample by using the initially trained disambiguation model based on the merged text content sample, to obtain a target entity content sample corresponding to the mention text content sample;
a calculation subunit, configured to calculate model loss information based on the target entity content sample; and
a parameter adjustment subunit, configured to perform parameter adjustment on the initially trained disambiguation model based on the model loss information, to obtain the preset disambiguation model.

In an embodiment, the calculation subunit may include:
a calculation module, configured to calculate a positive sample similarity between the positive mention text content sample and a target entity content sample corresponding to the positive mention text content sample and a negative sample similarity between the negative mention text content sample and a target entity content sample corresponding to the negative mention text content sample;
a nonlinear computation module, configured to respectively perform a nonlinear computation on the positive sample similarity and the negative sample similarity, to obtain a computed positive sample similarity and a computed negative sample similarity;
a statistics module, configured to perform a statistical computation on the computed positive sample similarity corresponding to the positive mention text content samples, to obtain a statistical positive sample similarity; and
a summation module, configured to perform summation on the statistical positive sample similarity to the computed negative sample similarity, to obtain the model loss information.

In an embodiment, the entity linking apparatus may include:
a second obtaining unit, configured to obtain a to-be-trained retrieval model, a first text content sample, and a second text content sample;
a third training unit, configured to perform pretraining on the to-be-trained retrieval model by using the first text content sample, to obtain an initially trained retrieval model; and a fourth training unit, configured to perform training on the initially trained retrieval model by using the second text content sample, to obtain the preset retrieval model, the first text content sample and the second text content sample being different text content samples.

In an embodiment, the third training unit may include:
a parsing subunit, configured to perform parsing on the first text content sample, to obtain at least one text content unit;
a determining subunit, configured to determine a target text content unit in the at least one text content unit;
a masking subunit, configured to perform masking on the target text content unit in the first text content sample, to obtain a masked text content sample; and
a training subunit, configured to perform training on the to-be-trained retrieval model by using the masked text content sample to obtain the initially trained retrieval model.

During specific implementation, the above units may be implemented as independent entities, or may be combined in different ways, or may be implemented as the same entity or a plurality of entities. For specific implementation of the above units, reference may be made to the above method embodiments, which are not described herein.

Through the above entity linking apparatus, time relevancy and quality of question recommendation performed by using an AI model can be ensured during the question recommendation.

An embodiment of this disclosure further provides a computer device. The computer device may include a terminal or a server. For example, the computer device may serve as an entity linking terminal. The terminal may be a mobile phone, a tablet computer, or the like. For another example, the computer device may be a server, for example, an entity linking server. FIG. 8 is a schematic structural diagram of a computer device according to an embodiment of this disclosure. The computer device may include components such as a processing unit 401 with one or more processing cores, a memory 402 with one or more computer-readable storage media, a power supply 403, and an input unit 404. A person skilled in the art may understand that a structure of the computer device shown in FIG. 8 does not constitute a limitation on the computer device, and the computer device may include more or fewer components than those shown in the figure, or some merged components, or different component arrangements.

Processing circuitry, such as the processor 401 is a control center of the computer device, is connected to all parts of the entire computer device by using various interfaces and lines, and executes various functions of the computer device and performs data processing by running or executing a software program and/or a module stored in the memory 402 and calling data stored in the memory 402. The processor 401 may include one or more processing cores. An application processor and a modem processor may be integrated in the processor 401. The application processor mainly processes an operating system, a user interface, an application, and the like. The modem processor mainly processes wireless communication. The modem processor may alternatively not be integrated in the processor 401.

The memory 402, such as a non-transitory computer-readable storage medium, may be configured to store the software program and the module, and the processor 401 executes various function applications and performs data processing by running the software program and the module stored in the memory 402. The memory 402 may mainly include a program storage area and a data storage area. The program storage area may store an operating system, an application required for at least one function (for example, a sound playback function and an image playback function), and the like. The data storage area may store data created based on use of the computer device, and the like. In addition, the memory 402 may include a high-speed random access memory, and may further include a non-volatile memory, such as at least one disk storage device, a flash memory device, or another volatile solid-state storage device. Correspondingly, the memory 402 may further include a memory controller, to provide access to the memory 402 for the processor 401.

The computer device further includes the power supply 403 that supplies power to each component. The power supply 403 may be logically connected to the processor 401 through a power management system, so that functions such as charging, discharging, and power management may be achieved through the power management system. The power supply 403 may further include any component such as one or more direct current or alternating current power supplies, a recharging system, a power failure detection circuit, a power converter or inverter, and a power status indicator.

The computer device may further include the input unit 404. The input unit 404 may be configured to receive inputted number or character information, and generate a keyboard, mouse, joystick, optical, or trackball signal input related to user settings and function control.

Although not shown in the figure, the computer device may further include a display unit, and the like. Details are not described herein. Specifically, in this embodiment, the processor 401 in the computer device loads executable files corresponding to processes of one or more applications to the memory 402 based on the following instructions, and the processor 401 runs the applications stored in the memory 402, to achieve various functions. The instructions include:
obtaining text content, the text content including mention text content and descriptive text content that explains the mention text content;
performing retrieval on at least one piece of preset entity content based on the descriptive text content of the mention text content, to obtain at least one piece of candidate entity content corresponding to the mention text content;
performing content filling on preset screening template content based on the mention text content, to obtain target screening template content;
performing content merging on the descriptive text content, the at least one piece of candidate entity content, and the target screening template content, to obtain merged text content; and
performing screening on the at least one piece of candidate entity content based on the merged text content, to obtain target entity content corresponding to the mention text content.

The above operations, reference may be made to the previous embodiments, and details are not described herein again.

According to an aspect of this disclosure, a computer program product or a computer program is provided, including computer instructions, the computer instructions being stored in a computer-readable storage medium. A processor of a computer device reads the computer instructions from the computer-readable storage medium, and executes the computer instructions, to cause the computer device to perform the methods provided in the implementations in the above embodiments.

A person skilled in the art may understand that all or some of the operations in the methods in the above embodiments may be completed by a computer program, or may be implemented by controlling relevant hardware through a computer program. The computer program may be stored in a non-transitory computer-readable storage medium and loaded and executed by a processor.

Therefore, an embodiment of this disclosure provides a storage medium, having a computer program stored therein, the computer program being configured to be loaded by a processor, to perform the operations in any entity linking method provided in the embodiments of this disclosure. For example, the computer program may perform the following operations:
obtaining text content, the text content including mention text content and descriptive text content that explains the mention text content;
performing retrieval on at least one piece of preset entity content based on the descriptive text content of the mention text content, to obtain at least one piece of candidate entity content corresponding to the mention text content;
performing content filling on preset screening template content based on the mention text content, to obtain target screening template content;
performing content merging on the descriptive text content, the at least one piece of candidate entity content, and the target screening template content, to obtain merged text content; and performing screening on the at least one piece of candidate entity content based on the merged text content, to obtain target entity content corresponding to the mention text content.

The above operations, reference may be made to the previous embodiments, and details are not described herein again. The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Since the computer program stored in the computer-readable storage medium can perform the operations in any entity linking method provided in the embodiments of this disclosure, the beneficial effects that can be implemented by any entity linking method provided in the embodiments of this disclosure can be achieved. For details, reference is made to the above embodiments, which are not described herein again.

The entity linking method and apparatus, the computer device, and the storage medium provided in the embodiments of this disclosure are described above in detail. The principle and the implementations of this disclosure is illustrated by using examples. The description of the above embodiments is merely configured for facilitating understanding of the method of this disclosure and the core idea thereof. In addition, a person skilled in the art may make modifications to the examples and without departing from the spirit and principle of this disclosure falls within the protection scope of this disclosure. In summary, the content of this specification is not to be construed as a limitation on this disclosure.

What is claimed is:

1. An entity linking method, the method comprising:
obtaining, by processing circuitry, text content including text characters and descriptive information that explains the text characters;
obtaining at least one candidate entity content corresponding to the text characters based on the descriptive information;
performing content filling on first screening template content based on the text characters to generate second screening template content;
generating merged text content based on the descriptive information, the at least one candidate entity content, and the second screening template content; and
obtaining target entity content corresponding to the text characters based on the merged text content.

2. The method according to claim 1, wherein the obtaining the at least one candidate entity content comprises:
obtaining coded text characters information corresponding to the text characters based on a text characters identifier;
obtaining coded descriptive information corresponding to the descriptive information based on a descriptive information identifier;
obtaining feature mining information of the coded text characters information based on the coded descriptive information; and
obtaining the at least one candidate entity content corresponding to the text characters based on the feature mining information.

3. The method according to claim 1, wherein the generating the merged text content further comprises:
generating an entity content identifier for each of the at least one candidate entity content;
obtaining at least one spliced entity content based on splicing each of the at least one candidate entity content and the entity content identifier of the respective candidate entity content;
obtaining masked screening template content based on masking the second screening template content; and
obtaining the merged text content based on splicing the descriptive information, the at least one spliced entity content, and the masked screening template content according to a preset splicing format.

4. The method according to claim 3, wherein the obtaining the target entity content further comprises:
obtaining coded merged information corresponding to the merged text content based on encoding the merged text content;
obtaining feature mining information corresponding to the merged text content; and
obtaining the target entity content based on performing prediction on masked information in the merged text content according to the feature mining information.

5. The method according to claim 1, wherein
the obtaining the at least one candidate entity content includes obtaining the at least one candidate entity content corresponding to the text characters based on the descriptive information with a preset retrieval model; and
the obtaining the target entity content includes obtaining the target entity content corresponding to the text characters based on the merged text content with a preset disambiguation model.

6. The method according to claim 5, wherein the obtaining the target entity content further comprises:
obtaining a to-be-trained disambiguation model, a text content sample, and at least one entity content sample;
obtaining an enhanced entity content sample based on information enhancement of the at least one entity content sample;
obtaining an initially trained disambiguation model by training the to-be-trained disambiguation model with the enhanced entity content sample; and
obtaining the preset disambiguation model by training the initially trained disambiguation model with the text content sample.

7. The method according to claim 6, wherein the obtaining the enhanced entity content sample comprises:
obtaining a first entity content sample and a second entity content sample by dividing a plurality of entity content samples into two types of entity content samples;
obtaining a masked entity content sample based on performing masking on the first entity content sample; and
obtaining the enhanced entity content sample based on splicing the masked entity content sample and the second entity content sample.

8. The method according to claim 6, wherein the obtaining the preset disambiguation model further comprises:
obtaining at least one candidate entity content sample corresponding to a sample of the text characters;
generating a merged text content sample based on the sample of the text characters, a sample of the descriptive information, and the at least one candidate entity content sample;
performing screening on the at least one candidate entity content sample with the initially trained disambiguation model based on the merged text content sample, to obtain a target entity content sample corresponding to the sample of the text characters;
calculating model loss information based on the target entity content sample; and
performing parameter adjustment on the initially trained disambiguation model based on the model loss information, to obtain the preset disambiguation model.

9. The method according to claim 8, wherein the calculating the model loss information comprises:
determining a positive sample similarity between a positive text characters sample and the target entity content sample;
obtaining a computed positive sample similarity;
obtaining a statistical positive sample similarity based on the computed positive sample similarity; and
obtaining the model loss information based on the statistical positive sample similarity.

10. The method according to claim 5, further comprising:
obtaining a to-be-trained retrieval model, a first text content sample, and a second text content sample;
obtaining an initially trained retrieval model based on pretraining the to-be-trained retrieval model with the first text content sample; and
obtaining the preset retrieval model based on training the initially trained retrieval model with the first text content sample and the second text content sample.

11. The method according to claim 10, wherein the obtaining the initially trained retrieval model comprises:
obtaining at least one text content unit from the first text content sample;
determining a target text content unit in the at least one text content unit;
obtaining a masked text content sample based on masking the target text content unit; and
obtaining the initially trained retrieval model based on training the to-be-trained retrieval model with the masked text content sample.

12. An entity linking apparatus, comprising:
processing circuitry configured to:
obtain text content including text characters and descriptive information that explains the text characters;
obtain at least one candidate entity content corresponding to the text characters based on the descriptive information;
perform content filling on first screening template content based on the text characters to generate second screening template content;
generate merged text content based on the descriptive information, the at least one candidate entity content, and the second screening template content; and
obtain target entity content corresponding to the text characters based on the merged text content.

13. The apparatus according to claim 12, wherein the processing circuitry is configured to:
obtain coded text characters information corresponding to the text characters based on a text characters identifier;
obtain coded descriptive information corresponding to the descriptive information based on a descriptive information identifier;
obtain feature mining information of the coded text characters information based on the coded descriptive information; and
obtain the at least one candidate entity content corresponding to the text characters based on the feature mining information.

14. The apparatus according to claim 12, wherein the processing circuitry is configured to:
generate an entity content identifier for each of the at least one candidate entity content;
obtain at least one spliced entity content based on splicing each of the at least one candidate entity content and the entity content identifier of the respective candidate entity content;
obtain masked screening template content based on masking the second screening template content; and
obtain the merged text content based on splicing the descriptive information, the at least one spliced entity content, and the masked screening template content according to a preset splicing format.

15. The apparatus according to claim 14, wherein the processing circuitry is configured to:
obtain coded merged information corresponding to the merged text content based on encoding the merged text content;
obtain feature mining information corresponding to the merged text content; and
obtain the target entity content based on performing prediction on masked information in the merged text content according to the feature mining information.

16. The apparatus according to claim 12, wherein the processing circuitry is configured to:
obtain the at least one candidate entity content corresponding to the text characters based on the descriptive information with a preset retrieval model; and
obtain the target entity content corresponding to the text characters based on the merged text content with a preset disambiguation model.

17. A non-transitory computer-readable storage medium, storing instructions which when executed by a processor cause the processor to perform:
obtaining text content including text characters and descriptive information that explains the text characters;
obtaining at least one candidate entity content corresponding to the text characters based on the descriptive information;
performing content filling on first screening template content based on the text characters to generate second screening template content;
generating merged text content based on the descriptive information, the at least one candidate entity content, and the second screening template content; and
obtaining target entity content corresponding to the text characters based on the merged text content.

18. The non-transitory computer-readable storage medium according to claim 17, wherein the obtaining the at least one candidate entity content comprises:
obtaining coded text characters information corresponding to the text characters based on a text characters identifier;
obtaining coded descriptive information corresponding to the descriptive information based on a descriptive information identifier;
obtaining feature mining information of the coded text characters information based on the coded descriptive information; and
obtaining the at least one candidate entity content corresponding to the text characters based on the feature mining information.

19. The non-transitory computer-readable storage medium according to claim 17, wherein the generating the merged text content further comprises:
generating an entity content identifier for each of the at least one candidate entity content;
obtaining at least one spliced entity content based on splicing each of the at least one candidate entity content and the entity content identifier of the respective candidate entity content;
obtaining masked screening template content based on masking the second screening template content; and
obtaining the merged text content based on splicing the descriptive information, the at least one spliced entity content, and the masked screening template content according to a preset splicing format.

20. The non-transitory computer-readable storage medium according to claim 19, wherein the obtaining the target entity content further comprises:
obtaining coded merged information corresponding to the merged text content based on encoding the merged text content;
obtaining feature mining information corresponding to the merged text content; and
obtaining the target entity content based on performing prediction on masked information in the merged text content according to the feature mining information.
